(19) United States
(12) Patent Application Publication
(10) Pub. No.: US 2015/0120600 A1
(43) Pub. Date: Apr. 30, 2015

(54) TIME AND LOCATION BASED DELIVERY OPTIMIZATION

(71) Applicants: Tianyu Luwang, Shanghai (CN); Mengjiao Wang, Shanghai (CN); Wen-Syan Li, Fremont, CA (US)

(72) Inventors: Tianyu Luwang, Shanghai (CN); Mengjiao Wang, Shanghai (CN); Wen-Syan Li, Fremont, CA (US)

(73) Assignee: SAP AG, Walldorf (DE)

(21) Appl. No.: 14/076,195

(22) Filed: Nov. 9, 2013

(30) Foreign Application Priority Data
Oct. 31, 2013 (CN) 201310532551.8

(51) Int. Cl. G06Q 10/08

(52) U.S. Cl. CPC G06Q 10/08355
USPC 705/338

(57) ABSTRACT

Methods, systems, and computer program products for logistics management are described. A root node in a tree representing a home base may be established, the root node comprising a capacity of a corresponding delivery vehicle. One or more unassigned delivery points may be added as a child node of the root node if a path to the corresponding unassigned delivery point is feasible. A next level delivery point may be added as a child node of a node in a tree level_{index} if the delivery point is unassigned and a path to the next level delivery point is feasible. The adding step may be repeated for each combination of unassigned delivery point and node(s) in the tree level_{index}.

### CLAIM OF PRIORITY

The present patent application claims the priority benefit of the filing date of Chinese Application (SIPO) No. 201310532551.8 filed Oct. 31, 2013, the entire content of which is incorporated herein by reference.

### FIELD

The present disclosure relates, generally, to logistics. In an example embodiment, the disclosure relates to time and location based optimization of delivery tasks.

### BACKGROUND

Package delivery companies often need to deliver an item to a customer during a specific period of time. For example, some customers may only be able to receive a delivery at home when they return from work. In regard to the supply chain of retail stores, some stores may only be able to receive supplies, such as new products, during certain periods of time. For example, a store may only be able to receive supplies when there are only a few customers in the store, when they have enough available inventory space, and/or when personnel are available to receive a shipment.

In common logistics practices, the schedule and route of delivery vehicles may consider customers' locations, but may ignore considerations of detailed timing. The schedule and route may be fixed for a certain period of time (such as several weeks or months) and may not be able to consider changes in customers' demands, such as temporal constraints. For example, a fixed schedule may not be able to accommodate customers that may require different delivery time(s) on different days. As a result, service quality and customer loyalty may be reduced, and reduced efficiency may lead to higher costs. For example, if delivery optimization ignores detailed timing, more vehicles and drivers may be needed to accomplish delivery tasks.

### BRIEF DESCRIPTION OF DRAWINGS

The present disclosure is illustrated by way of example and not limitation in the figures of the accompanying drawings, in which like references indicate similar elements and in which:

FIGS. 1A and 1B illustrate schematic diagrams of example systems for logistics management, in accordance with an example embodiment;

FIG. 2 is a representation of an example package delivery table for managing package delivery, in accordance with an example embodiment;

FIG. 3 is a block diagram of an example system workflow for managing package delivery, in accordance with an example embodiment;

FIG. 4 is a block diagram of an example apparatus for managing package delivery, in accordance an example embodiment;

FIG. 5 is a representation of an example tree structure for managing package delivery, in accordance with an example embodiment;

FIG. 6 is a flowchart illustrating an example workflow for managing package delivery, in accordance with an example embodiment;

FIG. 7 is a flowchart illustrating an example method for constructing a tree in a breadth-first manner for scheduling package delivery, in accordance with an example embodiment;

FIG. 8 is a flowchart illustrating an example method for pruning a constructed tree, in accordance with an example embodiment; and

FIG. 9 is a block diagram of a computer processing system within which a set of instructions, for causing the computer to perform any one or more of the methodologies discussed herein, may be executed.

### DETAILED DESCRIPTION

The description that follows includes illustrative systems, methods, techniques, instruction sequences, and computing program products that embody example embodiments of the present invention. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures and techniques have not been shown in detail.

Generally, methods, systems, apparatus, and computer program products for logistics management are disclosed. In one example embodiment, package delivery may be managed and the location and the timing constraints of each delivery may be considered in managing the overall package delivery schedule. In one example embodiment, an objective of managing package delivery may include: 1) meeting the delivery time requirement for each delivery; 2) minimizing the number of trucks that are needed for all deliveries; 3) maximizing the profit of a fleet of one or more trucks for executing the delivery route(s); and 4) minimizing the overall delivery time, travel distance, and/or travel time.

A delivery time requirement from a customer may comprise a time window requirement: the truck should arrive at the delivery point during a specified period of time. This delivery time may be required by the customer directly (e.g., the time period between the customer returning from work and before retiring for the night) or may be an implicit requirement (e.g., a reasonable delivery time period for a typical customer (for instance, 8 AM-8 PM)). Such an on time delivery may improve service quality and reduce the waiting time of the delivery driver. In certain situations, such an on time delivery may reduce the package unloading time as the customer may be more prepared for collecting deliveries.

Minimizing the number of trucks and/or deliverymen that are needed for all deliveries may be very important for cost control. A lower number of trucks may mean a lower asset investment and lower maintenance costs. In addition, fewer truck drivers may be needed to fulfill all the tasks, which may mean reduced personal costs, increased personal utilization, and higher employee loyalty.

Profit maximization may require more deliveries, shorter total travel distance, and/or less total trip time for a route. More deliveries may mean less unused capacity, which may lead to less waste. Shorter total travel distance may lead to lower fuel consumption, and may reduce cost and pollution.

Minimizing delivery time, total trip time and/or total trip distance may lead to lower personal costs and reduced fatigue of truck drivers, which may help improve driving safety. In one example embodiment, profit may be used as the index to incorporate the factors described above.

In one example embodiment, a tree structure may be used to find feasible delivery routes for the package delivery. A feasible delivery route is a route that meets one or more of the defined scheduling constraints, such as truck capacity, customer availability, and the like. Similarly, a path to a delivery point is feasible if it meets defined scheduling constraints, such as truck capacity, customer availability, and the like. Based on the feasible delivery routes, one or more optimal routes may be determined. An optimal route is a route that may rank high in terms of one or more of low delivery cost, low total travel time, total number of deliveries, truck utilization, route profit, and the like. One or more routes may then be selected from the optimal routes based on certain factors and the selected routes may be used for the final delivery schedule.

In one example embodiment, a tree of feasible delivery routes may be pruned during and/or after the construction process. Some non-optimal feasible routes (e.g., routes with high cost, long total travel time, and the like) may be removed from the tree so that the construction speed of the tree may be improved. The search for optimal routes may be faster based on a smaller set of feasible routes.

### Multi-Tiered Enterprise Computing Systems

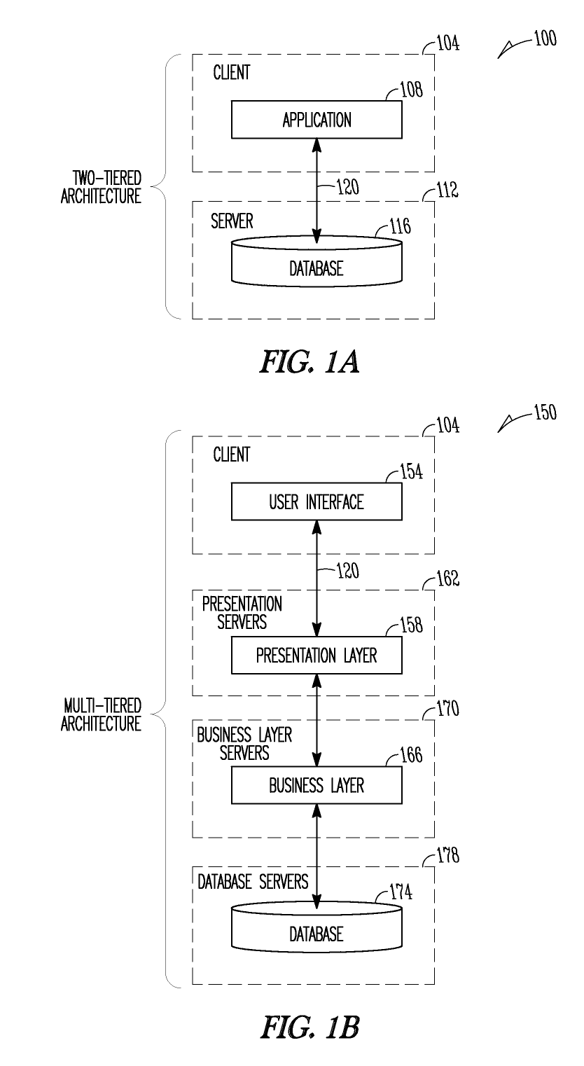

FIGS. 1A and 1B illustrate schematic diagrams of example systems 100, 150 for logistics management, in accordance with an example embodiment. Traditional client-server systems may employ a two-tiered architecture such as that illustrated by system 100 in FIG. 1A. Application 108 executed on the client 104 of the two-tiered architecture may be comprised of a monolithic set of program code including a graphical user interface component, presentation logic, business logic and a network interface that enables the client 104 to communicate over a network 120 with one or more servers 112. A database 116 may be maintained on the server 112 that provides non-volatile or “persistent” storage for the data accessed and/or processed by the application 108.

The “business logic” component of the application 108 may represent the core program code of the application 108, i.e., the rules governing the underlying business process (or other functionality) provided by the application 108. The “presentation logic” may describe the specific manner in which the results of the business logic are formatted for display on the user interface. The “database” 116 may include data access logic used by the business logic to store and retrieve data.

In response to limitations associated with the two-tiered client-server architecture, a multi-tiered architecture has been developed, as illustrated in FIG. 1B. In the multi-tiered system 150, the presentation layer 158, business layer 166 and database 174 may be logically separated from the user interface 154 of the application. These layers may be moved off of the client 104 to one or more dedicated servers on the network 120. For example, the presentation layer 158, the business layer 166, and the database 174 may each be maintained on separate servers (e.g., presentation servers 162, business layer servers 170 and database servers 178).

This separation of logical components and the user interface 154 may provide a more flexible and scalable architecture compared to that provided by the two-tiered model of the system 100 in FIG. 1A. For example, the separation may ensure that all clients 104 share a single implementation of business layer 166. If business rules change, changing the current implementation of business layer 166 to a new version may not call for updating any client-side program code. In addition, the presentation layer 158 may be provided, which generates code for a variety of different user interfaces 154, which may be standard browsers.

In one example embodiment, the input to the system may include:
H: set of home bases for delivery trucks
D: set of demand points, indexed by d
[TS_{d}, TE_{d}]: required delivery time window for demand point d
TW: maximum wait time at the demand point
W_{d}: weight of the delivery for demand point d
V_{d}: volume of the delivery for demand point d
TU_{d}: unloading time for demand point d
R_{d}: delivery fee (revenue) for the delivery at demand point d
C: capacity of the truck (measured by weight and/or volume)
T_{i,j}: travel time from point i to point j (including home bases and demand points)
F_{i,j}: travel distance from point i to point j (including home bases and demand points)
G: cost for a truck to travel a unit distance
P: cost for a truck driver to be outside of home base per unit of time

In one example embodiment, there may be one home base H for all delivery trucks. In one example embodiment, the intermediate data may include:
Cₙ: remaining capacity of the truck after visiting node n in the tree
[ASₙ, AEₙ]: feasible arrival time window for node n in the tree
[LSₙ, LEₙ]: feasible departure time window for node n in the tree

In one example embodiment, the output of the system may be multiple route assignments, each of which may include:
an identification of the truck
a route (a sequence of deliveries for a truck)
a departure time window for the truck from the home base
related statistics (e.g., total cost for the truck, total distance to travel for the truck, total delivery time for the truck, and total number of deliveries for the truck)

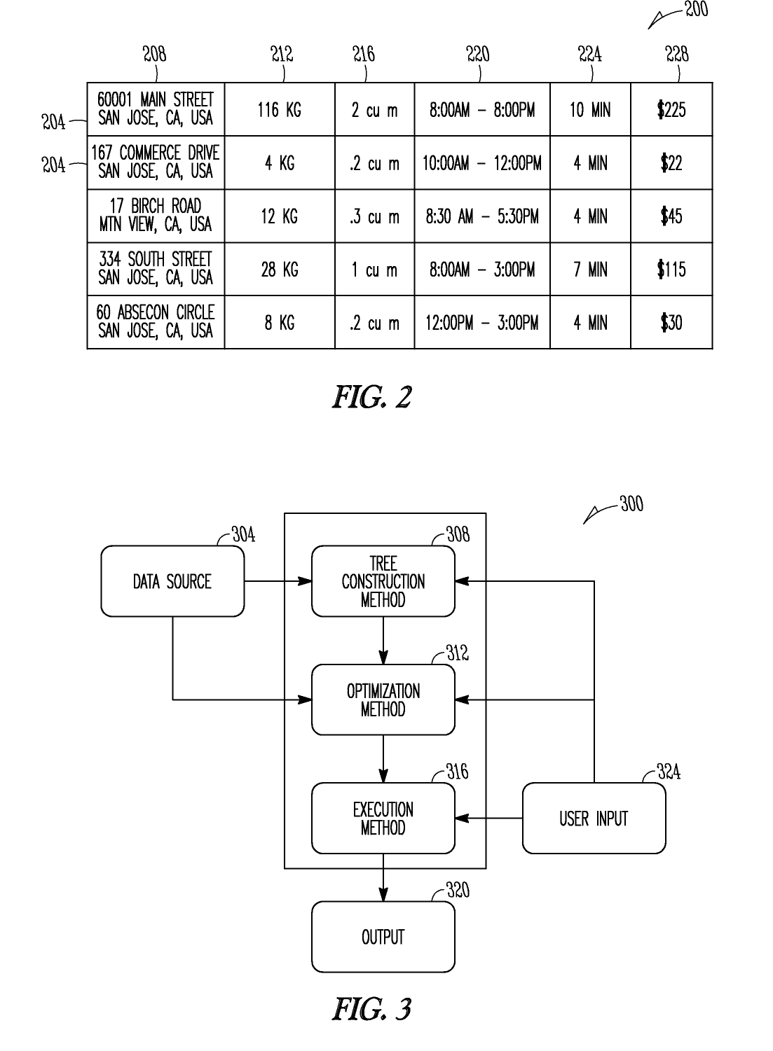

FIG. 2 is a representation of an example package delivery table 200 for managing package delivery, in accordance with an example embodiment. The package delivery table 200 may provide basic information for computing delivery routes for a fleet of trucks, in accordance with an example embodiment. Each row 204 corresponds to a package delivery point. Column 208 comprises a delivery point identifier (e.g., an address), column 212 comprises a total weight of one or more packages for the corresponding delivery point 204, column 216 comprises a total volume of one or more packages for the corresponding delivery point 204, column 220 comprises a delivery time window for the corresponding delivery point 204, column 224 comprises an amount of time required for unloading the one or more packages for the corresponding delivery point 204, and column 228 comprises a delivery fee for the corresponding delivery point 204.

### System Layout

FIG. 3 is a block diagram of an example system workflow 300 for managing package delivery, in accordance with an example embodiment. A data source 304 may be a database system that may store all or a portion of the input data. For example, the data source 304 may be the HANA system produced by SAP AG of Walldorf, Germany. A tree construction method 308 may construct a tree utilizing the input data from the data source 304 and, optionally, from user input 324, and may compute a set of feasible routes that are represented in a tree structure, as described more fully above. An optimization method 312 may find one or more optimal routes based on the constructed tree. User input 324 may provide all or part of the input data and may provide parameters for the tree construction method 308 and/or the optimization method 312. For example, a user may set the maximum driver travel time between delivery points Tₙₘ.

An execution method 316 may be used to compare optimal routes and select one or more of the optimal routes. For example, the execution method 316 may automatically select the highest ranking routes determined by the optimization method 312 or may assist a user in comparing the optimal routes and selecting one or more of the optimal routes for package delivery. The output 320 may comprise the selected optimal route(s) and a delivery schedule that may be sent to each truck's driver.

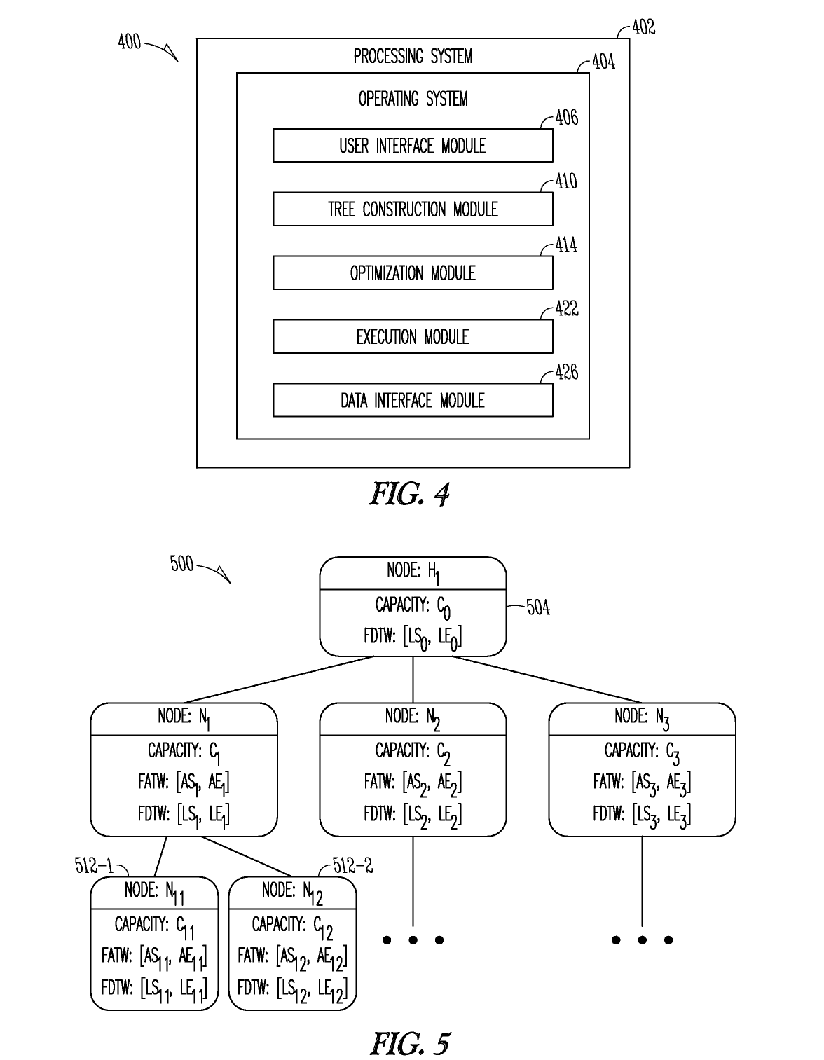

FIG. 4 is a block diagram of an example apparatus 400 for managing package delivery, in accordance with an example embodiment. For example, the apparatus 400 may be used to generate a set of delivery routes for a set of truck drivers.

The apparatus 400 is shown to include a processing system 402 that may be implemented on a server, client, or other processing device that includes an operating system 404 for executing software instructions. In accordance with an example embodiment, the apparatus 400 may includes a user interface module 406, a tree construction module 410, an optimization module 414, and an execution module 422. In accordance with an example embodiment, the apparatus 400 may include a data interface module 426.

The user interface module 406 may import input information, such as a list of delivery points and package characteristics, fleet availability and truck characteristics, delivery time constraints, and the like, as described more fully above.

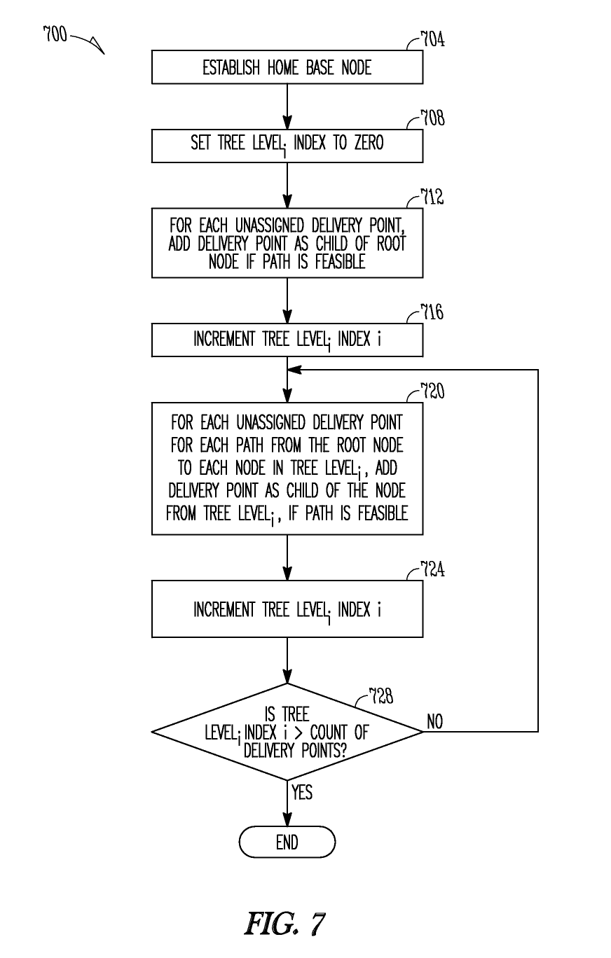

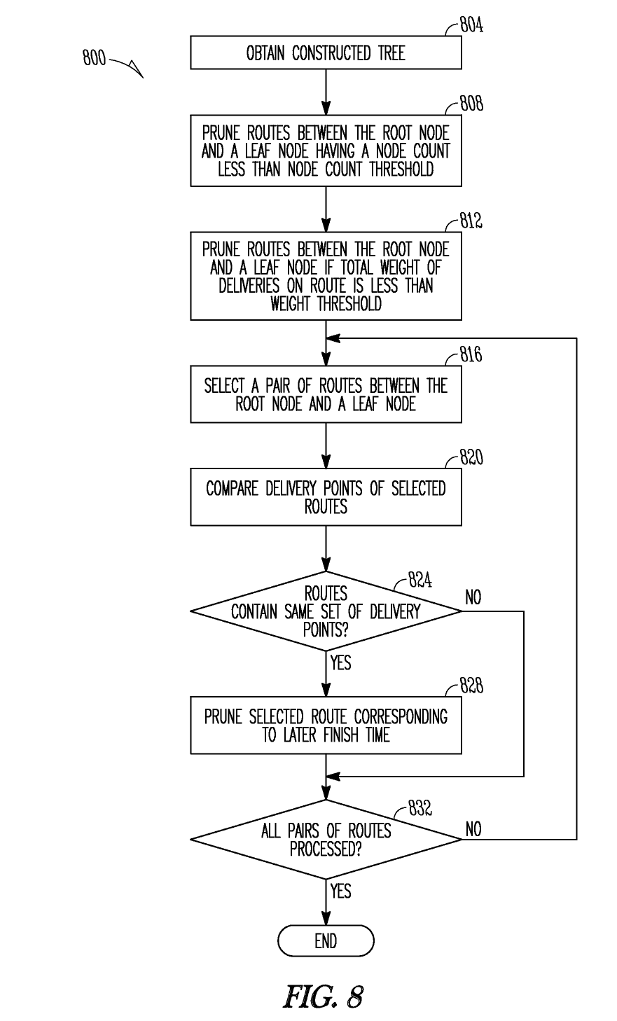

The tree construction module 410 may construct the tree structure 500, as described more fully below in conjunction with FIGS. 5 and 7. Each path in the tree may represent a possible delivery route for a corresponding delivery truck.

The optimization module 414 may optimize the selection of truck delivery routes. In one example embodiment, the optimization module 414 may identify one or more optimal truck delivery routes by optimizing one or more delivery objectives, such as maximizing revenue, maximizing profit, minimizing travel distance, and the like.

The execution module 422 may select an optimal route from a set of optimal routes. In one example embodiment, the execution module 422 may assist a user in selecting the final delivery route for each truck. For example, the execution module 422 may assist the user in identifying the most profitable route(s) for a selected delivery truck.

### Tree Representation

FIG. 5 is a representation of an example tree structure 500 for managing package delivery, in accordance with an example embodiment. In the tree structure 500, a path from the root node 504 to a leaf node 512-1 or leaf node 512-2 may represent a feasible route for a delivery truck. The root node 504 may represent a home base for a delivery truck(s). Other nodes in the tree structure 500 may represent demand points (delivery points). In each root-to-leaf path, the child node is the next point the truck will visit after visiting the parent node. The capacity of each node Cn equals the total capacity of the truck minus the total weight of all nodes on the path from the root node 504 to a current node. Each non-root node in the tree should be reached according to its required delivery time window. A truck should arrive at the non-root node at some time during the corresponding time window or within a certain time before the start of the time window (this means the driver may wait for a certain time, the maximum of which is TW). After unloading and delivering the package, the truck may leave for the next point in the path. Each non-root node has a feasible arrival time window (FATW) and each node has a feasible departure time window (FDTW).

As noted above, the root node 504 may be a home base. The capacity of the root node 504 may, therefore, be the whole capacity of the truck. The FDTW of the root node 504 may be the time window that the truck is fully loaded and may leave its home base. The tree structure 500 may be constructed in depth first or breadth first fashion, as described more fully below. For each node n in the tree structure 500, the system searches for reachable and deliverable unvisited points if the truck leaves the node during its feasible departure time window. For an unvisited point m, its arrival time window is [LSₙ+Tₙₘ, LEₙ+Tₙₘ] and its feasible arrival time window is:

[ASₘ,AEₘ]=[LSₙ+Tₙₘ,LEₙ+Tₙₘ]∩[TSₘ−TW,TEₘ]

For this point to be reachable, it should satisfy:

[LSₙ+Tₙₘ,LEₙ+Tₙₘ]∩[TSₘ−TW,TEₘ]≠Ø

This may mean that the truck could arrive at that point during its required delivery time window or within a certain time before the start of the time window (not larger than TW, however). For this point to be deliverable, it should satisfy:

Wₘ≦Cₙ

This means that the truck should have enough remaining capacity for point m. If point m satisfies these requirements, it may be added to the tree structure 500 as a child of node n. (Points m and n are two consecutive delivery points in a feasible path.) Some reachable and deliverable unvisited points of node n may not be added as its child if a related feasible path would not be acceptable. For example, if the travel time from n to m (Tₙₘ) is too long the path may not be acceptable. (In one example embodiment, a user may define Tₙₘ) In this case, one or more trucks should be dispatched in order to make delivery for those unvisited points. The same process can be used to find optimal routes for newly added trucks. Other pruning techniques may be applied during the tree construction process. If point m is added to the tree structure 500 as a child of node n, its feasible departure time window is:

[LSₘ,LEₘ]=[max(ASₘ,TSₘ)+TUₘ,max(AEₘ,TSₘ)+TUₘ]

The whole construction process may be ended if no more nodes can be added to the tree structure 500.

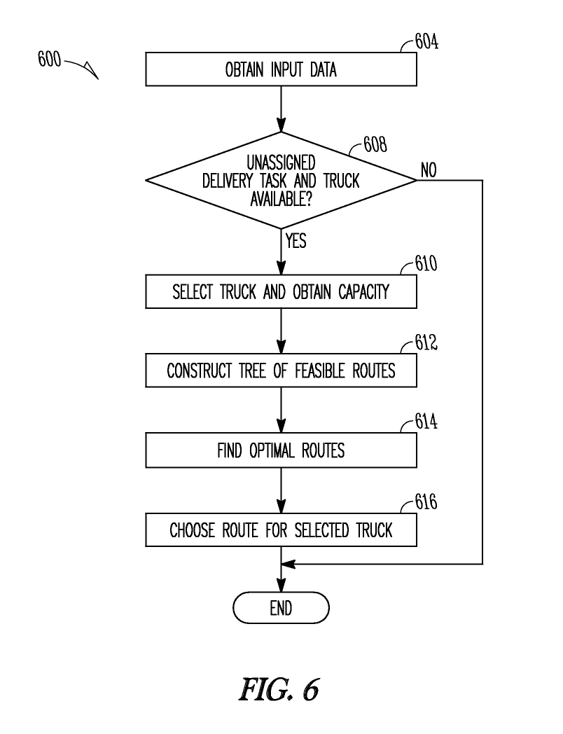

FIG. 6 is a flowchart illustrating an example workflow 600 for managing package delivery, in accordance with an example embodiment. Input data may be obtained from, for example, data source 304 (operation 604). A test may be performed to determine if there are unassigned delivery tasks and if there are available trucks in a corresponding time window (operation 608). If there are no unassigned delivery tasks or if there are no available trucks in a corresponding time window, the method may end; otherwise, an available truck may be selected and the corresponding capacity may be obtained (operation 610). A tree structure (e.g., tress structure 500) may be constructed to find the feasible delivery routes (operation 612) and one or more optimal routes may be selected through an optimization process (operation 614). A route may be selected from the one or more optimal routes and may be assigned to the selected truck (operation 616). For example, a user may select a route from the one or more optimal routes. The method may proceed with operation 608.

In one example embodiment, there may not be a single feasible route that can cover all deliveries. In this case, a set of routes for a set of trucks may be determined. The process may, therefore, be a greedy way to assign delivery tasks to different trucks. In one example embodiment, in each iteration, the method searches for the best route for each selected truck.

### Tree Construction

FIG. 7 is a flowchart illustrating an example tree construction method 700 for constructing a tree in a breadth-first manner for scheduling package delivery, in accordance with an example embodiment. The tree construction method 700 may be performed by the tree construction module 410.

In one example embodiment, a node for the home base may be established with the node indicating the capacity of the truck at the home base (operation 704) and a tree level index may be set to zero (operation 708).

For each unassigned delivery point, the delivery point is added as a child of the root node if the path to the delivery point is feasible (operation 712). The tree level index, i, may then be incremented (operation 716).

For each unassigned delivery point for each path from the root node to each node in the tree level i, the delivery point may be added as a child of a node in the tree level index i if the path to the delivery point is feasible (operation 720).

The tree level index i may be incremented (operation 724).

A test is then performed to determine if tree level index i is equal to the number of delivery points (operation 728). If the tree level index i is greater than the number of delivery points, the method may end; otherwise the method proceeds with operation 720.

### Tree Pruning

In order to efficiently find an optimal route, the size of the tree structure 500 may be reduced as a large tree may result in a time consuming construction and searching. The tree pruning may occur during and/or after construction of the tree structure 500. Several tree pruning techniques may be applied during the tree construction process:

1. pruning routes that contain only a few number of nodes, as such types of routes may require a larger number of trucks to cover all deliveries (for example, routes containing a number of nodes less than a node count threshold may be pruned);
2. pruning routes where the total weights of deliveries on the routes are lower than a weight threshold (low utilization);
3. if two routes contain the same set of nodes, prune the route whose finish time is later; and
4. if two routes contain the same set of nodes, prune the route whose travel distance is longer.

FIG. 8 is a flowchart illustrating an example method 800 for pruning a constructed tree, in accordance with an example embodiment. The method 800 may be performed, for example, by the tree construction module 410.

In one example embodiment, a constructed tree may be obtained (operation 804). Routes that contain a count of nodes less than a node count threshold may be pruned from the tree (operation 808). Routes that comprise a total delivery weight of less than a weight threshold may be pruned from the tree (operation 812). In one example embodiment, a user may set the node count threshold and the weight threshold.

A pair of routes from the tree may be selected, each selected route beginning at the root node and ending at a leaf node (operation 816) and delivery points of the pair of selected routes may be compared (operation 820). A test may be performed to determine if the sets of delivery points are the same (operation 824). If the sets of delivery points are the same, the route of the pair of routes corresponding to the later delivery finish time may be deleted (operation 828); otherwise, the method may proceed with operation 832.

During operation 832, a test may be performed to determine if all the pairs of routes beginning at the root node (e.g., root node 504) and ending at a leaf node (e.g., leaf node 512-1, 512-2) have been processed. If all pairs of routes beginning at the root node (e.g., root node 504) and ending at a leaf node (e.g., leaf node 512-1, 512-2) have not been processed, the method may proceed with operation 816; otherwise, the method may end.

### Optimization

Each leaf node in a tree may represent a feasible delivery route, which traverses a path through the tree from the root node to the leaf node and returns from the leaf node to the home base directly. The total distance s is the sum of travel distances between all two consecutive nodes on the path and the direct distance from the leaf node to the home base. The actual departure time window from the home base may be computed through computation from the leaf node to the root node. The total travel times may be the same for different departure times of a route. However, an optimal time point or time window may be found by minimizing the total wait time of the route. The optimal total travel time may be represented as e. The total delivery revenue of a route may be the sum of delivery fees (revenues) for the deliveries at demand points along the path. This may be denoted as r. The profit o for the route may be computed as follows:

o=r−s G−t P

An objective may be to find the routes with largest profits. In one example embodiment, the profits of all routes are computed and the optimal routes are selected by ranking the routes based on profit.

In one embodiment, profits of all routes may be computed. The optimal routes may be selected by ranking the profits of the computed routes. Some constraints (e.g. maximal working time) may be used to reduce the number of candidate routes.

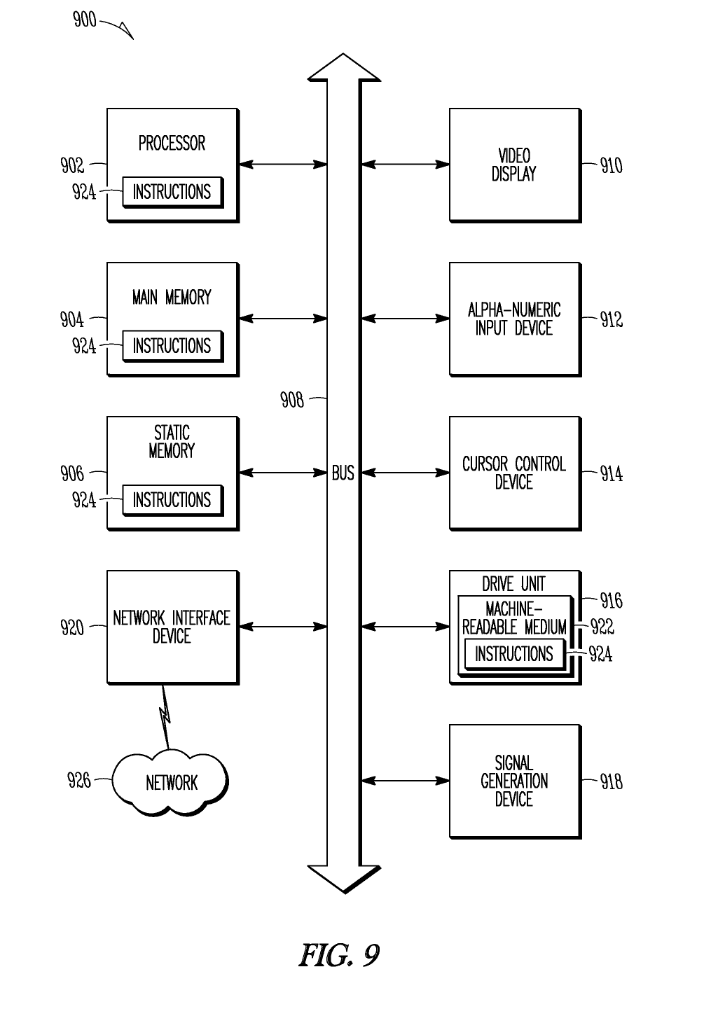

FIG. 9 is a block diagram of a computer processing system within which a set of instructions, for causing the computer to perform any one or more of the methodologies discussed herein, may be executed. In some embodiments, the computer operates as a standalone device or may be connected (e.g., networked) to other computers. In a networked deployment, the computer may operate in the capacity of a server or a client computer in server-client network environment, or as a peer computer in a peer-to-peer (or distributed) network environment.

In addition to being sold or licensed via traditional channels, embodiments may also, for example, be deployed by Software-as-a-Service (SaaS), Application Service Provider (ASP), or by utility computing providers. The computer may be a server computer, a personal computer (PC), a tablet PC, a set-top box (STB), a personal digital assistant (PDA), cellular telephone, or any processing device capable of executing a set of instructions (sequential or otherwise) that specify actions to be taken by that device. Further, while only a single computer is illustrated, the term “computer” shall also be taken to include any collection of computers that, individually or jointly, execute a set (or multiple sets) of instructions to perform any one or more of the methodologies discussed herein.

The example computer processing system 900 includes a processor 902 (e.g., a central processing unit (CPU), a graphics processing unit (GPU) or both), a main memory 904 and static memory 906, which communicate with each other via a bus 908. The computer processing system 900 may further include a video display unit 910 (e.g., a plasma display, a liquid crystal display (LCD) or a cathode ray tube (CRT)). The computer processing system 900 also includes an alphanumeric input device 912 (e.g., a keyboard), a user interface (UI) navigation device 914 (e.g., a mouse, touch screen, or the like), a drive unit 916, a signal generation device 918 (e.g., a speaker), and a network interface device 920.

The drive unit 916 includes machine-readable medium 922 on which is stored one or more sets of instructions 924 and data structures embodying or utilized by any one or more of the methodologies or functions described herein. The instructions 924 may also reside, completely or at least partially, within the main memory 904, static memory 906, and/or within the processor 902 during execution thereof by the computer processing system 900, the main memory 904, static memory 906, and the processor 902 also constituting machine-readable, tangible media.

The instructions 924 may further be transmitted or received over network 926 via a network interface device 920 utilizing any one of a number of well-known transfer protocols (e.g., Hypertext Transfer Protocol).

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions 924. The term “machine-readable medium” shall also be taken to include any medium that is capable of storing, encoding or carrying a set of instructions 924 for execution by the computer and that cause the computer to perform any one or more of the methodologies of the present application, or that is capable of storing, encoding or carrying data structures utilized by or associated with such a set of instructions 924. The term “machine-readable medium” shall accordingly be taken to include, but not be limited to, solid-state memories, and optical and magnetic media.

While the invention(s) is (are) described with reference to various implementations and exploitations, it will be understood that these embodiments are illustrative and that the scope of the invention(s) is not limited to them. In general, techniques for maintaining consistency between data structures may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A computerized method for managing package delivery, the method comprising:
establishing a root node in a tree representing a home base and comprising a capacity of a corresponding delivery vehicle;
setting an index to an initial value, the index representing a level of the tree;
adding one or more unassigned delivery points as a child node of the root node if a path to the corresponding unassigned delivery point is feasible;
setting the index to the initial value plus one;
adding a next level delivery point as a child node of a node in a tree level_{index} if the delivery point is unassigned and a path to the next level delivery point is feasible, the adding step being repeated for each combination of unassigned delivery point and node in the tree level_{index};
incrementing the index; and
repeating the adding a next level delivery point and the incrementing until the index is greater than a count of delivery points.

2. The method of claim 1, wherein an unvisited delivery point m has an arrival time window of [LSₙ+Tₙₘ, LEₙ+Tₙₘ] and a feasible arrival time window of
[ASₘ,AEₘ]=[LSₙ+Tₙₘ,LEₙ+Tₙₘ]∩[TSₘ−TW,TEₘ],
where LSₙ is a start of a feasible time window for node n in the tree;
LEₙ is an end of the feasible time window for node n in the tree;
Tₙₘ is a travel time from point n to point m;
TSₘ is a start of a required time window for demand point d;
TEₘ is an end of the required time window for demand point d;
ASₘ is a start of the feasible arrival time window for node n in the tree;
AEₘ is an end of a feasible arrival time window for node n in the tree; and
TW is a maximum wait time at a demand point.

3. The method of claim 2, wherein a delivery point is feasible if
[LSₙ+Tₙₘ,LEₙ+Tₙₘ]∩[TSₘ−TW,TEₘ]≠Ø and Wₘ≦Cₙ
where LSₙ is a start of a feasible time window for node n in the tree;
LEₙ is an end of the feasible time window for node n in the tree;
Tₙₘ is a travel time from point n to point m;
TSₘ is a start of a required time window for demand point d;
TEₘ is an end of the required time window for demand point d;
Wₘ is a weight of a delivery for demand point m;
C is a capacity of a truck; and
TW is a maximum wait time at a demand point.

4. The method of claim 2, wherein a feasible departure time window is
[LSₘ,LEₘ]=[max(ASₘ,TSₘ)+TUₘ,max(AEₘ,TSₘ)+TUₘ]
where LSₘ is a start of a feasible time window for node m in the tree;
LEₘ is an end of the feasible time window for node m in the tree;
TSₘ is a start of a required time window for demand point d;
ASₘ is a start of a feasible arrival time window for node n in the tree;
AEₘ is an end of the feasible arrival time window for node n in the tree; and
TUₘ is an unloading time for demand point m.

5. The method of claim 1, further comprising pruning paths that contain a count of nodes that is less than a node threshold.

6. The method of claim 1, further comprising pruning paths where a total weight of deliveries on the route is lower than a weight threshold.

7. The method of claim 1, further comprising pruning a path of a duplicate set of paths whose finish time is later than another path of the duplicate set.

8. The method of claim 1, further comprising pruning a path of a duplicate set of paths whose travel distance is longer than another path of the duplicate set.

9. The method of claim 1, wherein a profit for a route is o=r−s G−t P
where o is the profit;
r is a total delivery revenue for the route;
s is a sum of travel distances between consecutive nodes on the route and a direct distance from a leaf node to the home base;
G is a cost for a truck to travel a unit distance;
t is a total travel time; and
P is a cost for a truck driver to be outside the home base per unit of time.

10. An apparatus for managing package delivery, the apparatus comprising:
a processor;
memory to store instructions that, when executed by the processor cause the processor to:
establish a root node in a tree representing a home base and comprising a capacity of a corresponding delivery vehicle;
set an index to an initial value, the index representing a level of the tree;
add one or more unassigned delivery points as a child node of the root node if a path to the corresponding unassigned delivery point is feasible;
set the index to the initial value plus one;
add a next level delivery point as a child node of a node in a tree level_{index} if the delivery point is unassigned and a path to the next level delivery point is feasible, the adding step being repeated for each combination of unassigned delivery point and node in the tree level_{index};
increment the index; and
repeat the adding a next level delivery point and the incrementing until the index is greater than a count of delivery points.

11. The apparatus of claim 10, wherein an unvisited delivery point m has an arrival time window of [LSₙ+Tₙₘ, LEₙ+Tₙₘ] and a feasible arrival time window of
[ASₘ,AEₘ]=[LSₙ+Tₙₘ,LEₙ+Tₙₘ]∩[TSₘ−TW,TEₙ],
where LSₙ is a start of a feasible time window for node n in the tree;
LEₙ is an end of the feasible time window for node n in the tree;
Tₙₘ is a travel time from point n to point m;
TSₘ is a start of a required time window for demand point d;
TEₘ is an end of the required time window for demand point d;
ASₘ is a start of the feasible arrival time window for node n in the tree;
AEₘ is an end of a feasible arrival time window for node n in the tree; and
TW is a maximum wait time at a demand point.

12. The apparatus of claim 11, wherein a delivery point is feasible if
[LSₙ+Tₙₘ,LEₙ+Tₙₘ]∩[TSₘ−TW,TEₘ]≠Ø and Wₘ≦Cₙ
where LSₙ is a start of a feasible time window for node n in the tree;
LEₙ is an end of the feasible time window for node n in the tree;
Tₙₘ is a travel time from point n to point m;
TSₘ is a start of a required time window for demand point d;
TEₘ is an end of the required time window for demand point d;
Wₘ is a weight of a delivery for demand point m;
C is a capacity of a truck; and
TW is a maximum wait time at a demand point.

13. The apparatus of claim 11, wherein a feasible departure time window is
[LSₘ,LEₘ]=[max(ASₘ,TSₘ)+TUₘ,max(AEₘ,TSₘ)+TUₘ]
where LSₘ is a start of a feasible time window for node m in the tree;
LEₘ is an end of the feasible time window for node m in the tree;
TSₘ is a start of a required time window for demand point d;
ASₘ is a start of a feasible arrival time window for node n in the tree;
AEₘ is an end of the feasible arrival time window for node n in the tree; and
TUₘ is an unloading time for demand point m.

14. The apparatus of claim 10, further comprising instructions that, when executed by the processor, cause the processor to prune paths that contain a count of nodes that is less than a node threshold.

15. The apparatus of claim 10, further comprising instructions that, when executed by the processor, cause the processor to prune paths where a total weight of deliveries on the route is lower than a weight threshold.

16. The apparatus of claim 10, further comprising instructions that, when executed by the processor, cause the processor to prune a path of a duplicate set of paths whose finish time is later than another path of the duplicate set.

17. The apparatus of claim 10, further comprising instructions that, when executed by the processor, cause the processor to prune a path of a duplicate set of paths whose travel distance is longer than another path of the duplicate set.

18. The apparatus of claim 10, wherein a profit for a route is o=r−s G−t P
where o is the profit;
r is a total delivery revenue for the route;
s is a sum of travel distances between consecutive nodes on the route and a direct distance from a leaf node to the home base;
G is a cost for a truck to travel a unit distance;
t is a total travel time; and
P is a cost for a truck driver to be outside the home base per unit of time.

19. A non-transitory machine-readable storage medium comprising instructions that, when executed by one or more processors of a machine, cause the machine to perform operations comprising:
establishing a root node in a tree representing a home base and comprising a capacity of a corresponding delivery vehicle;
setting an index to an initial value, the index representing a level of the tree;
adding one or more unassigned delivery points as a child node of the root node if a path to the corresponding unassigned delivery point is feasible;
setting the index to the initial value plus one;
adding a next level delivery point as a child node of a node in a tree level_{index} if the delivery point is unassigned and a path to the next level delivery point is feasible, the adding step being repeated for each combination of unassigned delivery point and node in the tree level_{index};
incrementing the index; and
repeating the adding a next level delivery point and the incrementing until the index is greater than a count of delivery points.

20. The non-transitory machine-readable storage medium of claim 19, wherein an unvisited delivery point m has an arrival time window of [LSₙ+Tₙₘ, LEₙ+Tₙₘ] and a feasible arrival time window of
[ASₘ,AEₘ]=[LSₙ+Tₙₘ,LEₙ+Tₙₘ]∩[TSₘ−TW,TEₘ],
where LSₙ is a start of a feasible time window for node n in the tree;
LEₙ is an end of the feasible time window for node n in the tree;
Tₙₘ is a travel time from point n to point m;
TSₘ is a start of a required time window for demand point d;
TEₘ is an end of the required time window for demand point d;
ASₘ is a start of the feasible arrival time window for node n in the tree;
AEₘ is an end of a feasible arrival time window for node n in the tree; and
TW is a maximum wait time at a demand point.
